(19) United States
(12) Patent Application Publication
(10) Pub. No.: US 2024/0078980 A1
(43) Pub. Date: Mar. 7, 2024

(54) DISPLAY DEVICE AND CONTROL METHOD THEREOF

(71) Applicant: HTC Corporation, Taoyuan City (TW)

(72) Inventor: Sheng-Yan Lin, Taoyuan City (TW)

(73) Assignee: HTC Corporation, Taoyuan City (TW)

(21) Appl. No.: 17/901,855

(22) Filed: Sep. 2, 2022

(51) Int. Cl. G09G 3/34; F21V 8/00; G09G 3/20; H05B 47/16

(52) U.S. Cl. CPC G09G 3/342; G02B 6/0068; G09G 3/2096; H05B 47/16; G09G 2320/0257; G09G 2320/0626

(57) ABSTRACT

A display device and a control method thereof are provided. The display device includes a display panel, a first light source, and a second light source. The first light source is disposed adjacent to a first side of the display panel corresponding to a first part display area of the display panel. The second light source is disposed adjacent to a second side of the display panel corresponding to a second part display area of the display panel, wherein the first side is opposite to the second side. The first light source and the second light source are respectively lit up during a first time period and a second time period, wherein an interval time is provided between the first time period and the second time period.

### TECHNICAL FIELD

The disclosure relates to a display device and a control method thereof, and in particular, to a display device and a control method thereof that improve display quality.

### DESCRIPTION OF RELATED ART

In the related art, the backlight light source of a virtual reality display has to wait until the signal of the liquid crystal display is completely scanned before it is lit up, so as to avoid afterimage. However, with the increase of display resolution and refresh rate, in the same frame period, the backlight light source may be lit up when the signal is not yet completely scanned or the liquid crystal has not yet reached a stable state. Such a situation will result in a serious afterimage phenomenon on the display screen.

### SUMMARY

The disclosure provides a display device and a control method thereof that improve the display quality.

The display device of the disclosure includes a display panel, a first light source, and a second light source. The first light source is disposed adjacent to a first side of the display panel corresponding to a first part display area of the display panel. The second light source is disposed adjacent to a second side of the display panel corresponding to a second part display area of the display panel, and the first side is opposite to the second side. The first light source and the second light source are respectively lit up during a first time period and a second time period, and an interval time is provided between the first time period and the second time period.

The control method of the disclosure includes: disposing a first light source adjacent to a first side of a display panel so that the first light source corresponds to a first part display area of the display panel, disposing a second light source adjacent to a second side of the display panel so that the second light source corresponds to a second part display area of the display panel, and the first side being opposite to the second side, and lighting up the first light source and the second light source respectively during a first time period and a second time period, and an interval time being provided between the first time period and the second time period.

Based on the above, the display device of the disclosure includes side-mounted first light source and second light source. The corresponding first light source is lightened after the pixel in the first part display area is stable, while the corresponding second light source is lightened after the pixel in the second part display area is stable. In this way, afterimage phenomenon in the display device due to the instable motion of the pixel during the lighting process is avoided, which effectively improves the display quality.

### BRIEF DESCRIPTION OF THE DRAWINGS

FIG. 1 is a schematic view of a display device according to one embodiment of the disclosure.

FIG. 2 is a sectional view of the display device according to the embodiment of FIG. 1 of the disclosure.

FIG. 3A to FIG. 3D are operational schematic views of the display device according to an embodiment of the disclosure.

FIG. 4 is a schematic view of a display device according to another embodiment of the disclosure.

FIG. 5 is a flowchart of a display device according to an embodiment of the disclosure.

FIG. 6 is a flowchart of a control method of a display device according to an embodiment of the disclosure.

### DESCRIPTION OF THE EMBODIMENTS

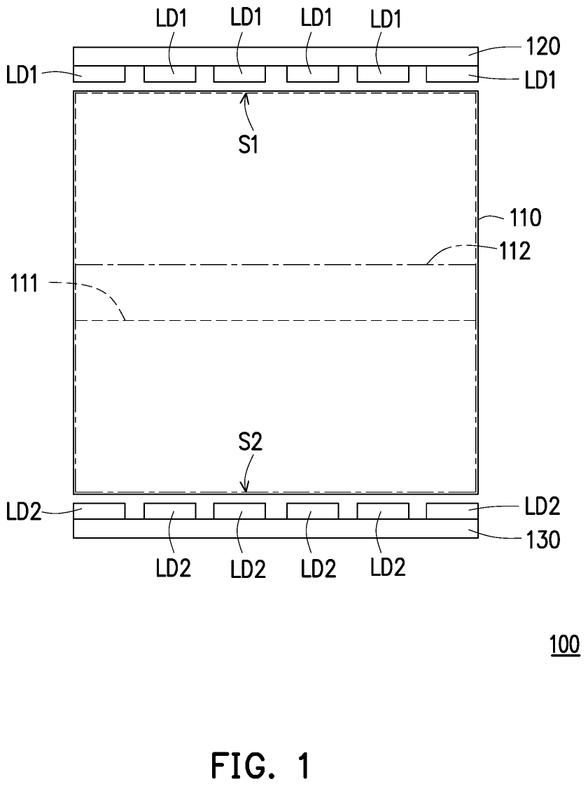

Referring to FIG. 1, FIG. 1 is a schematic view of a display device according to one embodiment of the disclosure. The display device 100 includes a display panel 110, a first light source 120, and a second light source 130. The first light source 120 may be disposed adjacent to a first side S1 of the display panel 110, while second light source 130 may be disposed adjacent to a second side S2 of the display panel 110. The first side S1 and the second side S2 are two opposite sides.

In this embodiment, the first light source 120 may be implemented through multiple light emitting diodes LD1 and form a light bar. Similarly, the second light source 130 may be implemented through multiple light emitting diodes LD2 and form another light bar. Certainly, in other embodiments of the disclosure, the first light source 120 and the second light source 130 may also be constructed using light strips formed by light emitters of any form known to those skilled in the art, without any special limitation. In this embodiment, the first light source 120 and the second light source 130 provide the display panel 110 side-mounted light source.

In addition, the display panel 110 in this embodiment may be a liquid crystal display panel and has multiple liquid crystal display pixels.

In FIG. 1, the first light source 120 corresponds to the first part display area 111 in the upper part of the display panel 110 and is configured to light up the first part display area 111 of the display panel 110. The second light source 130 corresponds to the second part display area 112 in the lower part of the display panel 110 and is configured to light up the second part display area 112 of the display panel 110. The first part display area 111 and the second part display area 112 may partially overlap each other, or the first part display area 111 and the second part display area 112 may not overlap each other.

Regarding the operation details, when the display device 100 executes an image display operation, the first light source 120 may be lightened up during a first time period, and the second light source 130 may be lightened up during a second time period. There may be an interval time between the first time period and the second time period. In detail, when the display device 100 executes the image display operation, display data of the first part display area 111 may be written before the first time period. In addition, the first light source 120 is lit up only during the first time period after the liquid crystal inversion operation corresponding to the written display data corresponding to the pixel of the first part display area 111 is stabilized.

On the other hand, the display data of the second part display area 112 may be continuously executed after the writing operation of the display data of the first part display area 111. In addition, the second light source 130 is lit up only during the second time period after the liquid crystal inversion operation corresponding to the written display data corresponding to the pixel of the second part display area 112 is stabilized.

It is worth mentioning that the first light source 120 and the second light source 130 of this embodiment are respectively lit up only after the pixels corresponding to the first part display area 111 and the second part display area 112 are stable. The first light source 120 and the second light source 130 is not lit up when the corresponding pixels are unstable, which may reduce the possibility of afterimage phenomenon in the generated display image and improve the display quality.

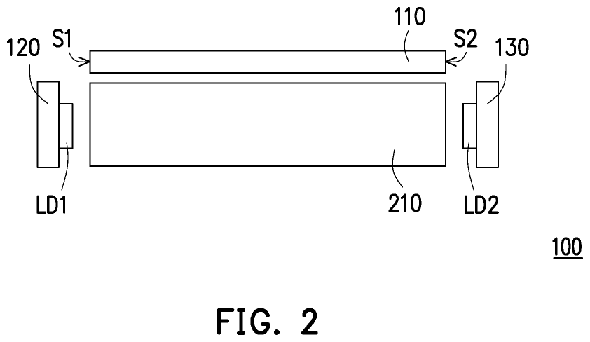

Referring to FIG. 1 and FIG. 2 at the same time, FIG. 2 is a sectional view of the display device according to the embodiment of FIG. 1 of the disclosure. In FIG. 2, the display device 100 further includes a light guiding plate 210. The light guiding plate 210 and the display panel 110 are disposed to overlap each other. The first light source 120 is disposed adjacent to a first side S1 of the display panel 110, while second light source 130 is disposed adjacent to a second side S2 of the display panel 110. The first light source 120 is constructed by multiple light emitting diodes LD1, while the second light source 130 is constructed by multiple light emitting diodes LD2.

In this embodiment, the light guiding plate 210 may transmit multiple first light beams sent by the first light source 120 to the first part display area 111 of the display panel 110. The light guiding plate 210 may transmit multiple second light beams sent by the second light source 130 to the second part display area 112 of the display panel 110.

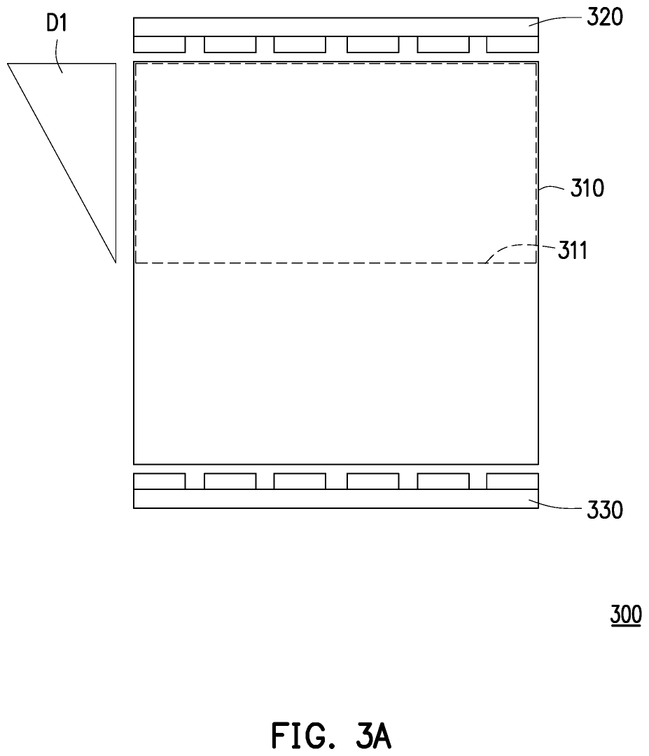

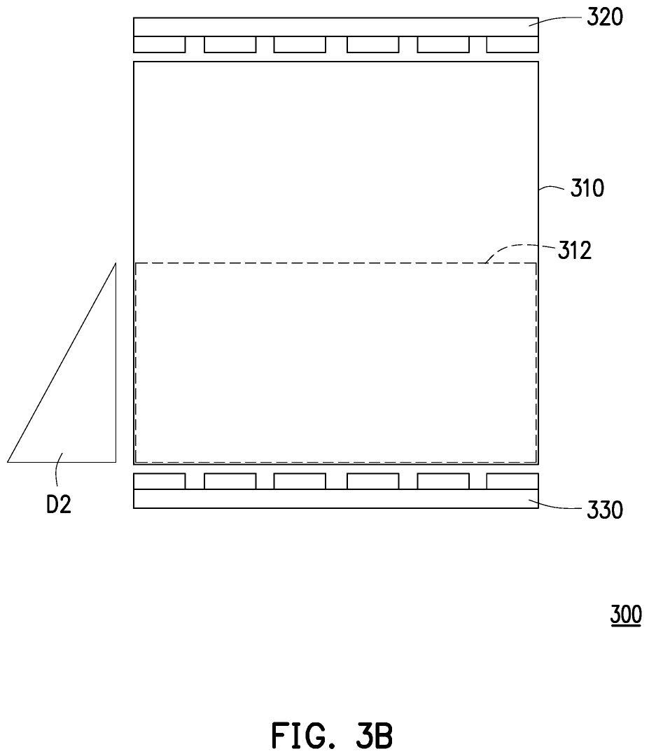

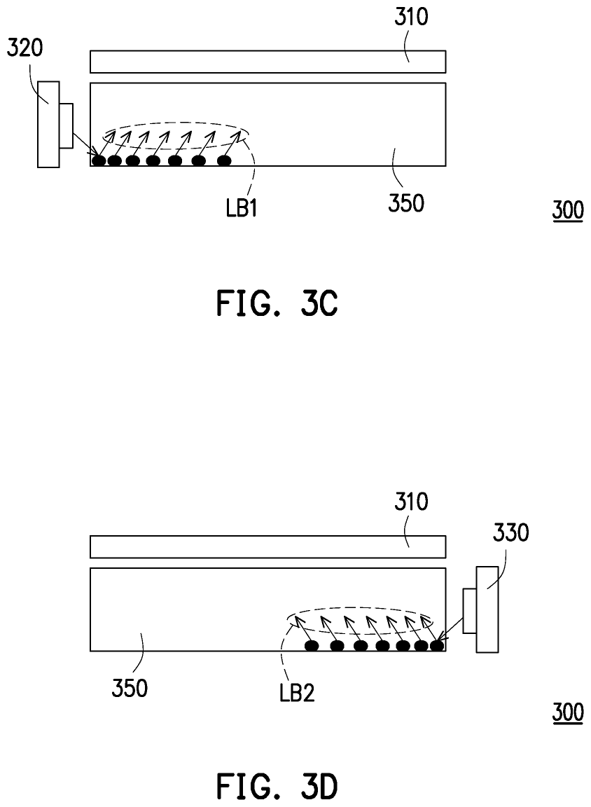

Referring to FIG. 3A to FIG. 3D, FIG. 3A to FIG. 3D are operational schematic views of the display device according to an embodiment of the disclosure. In FIG. 3A, the display device 300 includes a display panel 310, a first light source 320, and a second light source 330. The first light source 320 is disposed adjacent to an upper side of the display panel 310, while the second light source 330 is disposed adjacent to a lower side of the display panel 310. During the first time period, the first light source 320 may be lit up, and a first part display area 311 of the display panel 310 is also lit up correspondingly. At this time, the second light source 330 is not lit up. The display device 300 may execute a data writing operation of the second part display area other than the first part display area 311.

It is worth mentioning that, in FIG. 3A, the brightness of the first part display area 311 may be as shown in the brightness distribution D1, and the brightness of the first part display area 311 may gradually decrease as the distance from the first light source 320 increases.

Corresponding to FIG. 3A, in FIG. 3C, during the first time period, the first light source 320 may send multiple first light beams LB1 to the light guiding plate 350. The light guiding plate 350 may transmit first light beams LB1 to the first part display area 311 of the display panel 310, thereby lighting up the first part display area 311.

Next, in FIG. 3B, during the second time period, the second light source 330 may be lit up, and a second part display area 312 of the display panel 310 is also lit up correspondingly. At this time, the first light source 320 is not lit up. The display device 300 may execute a data writing operation of the first part display area 311 other than the second part display area 312.

It is worth mentioning that, in FIG. 3B, the brightness of the second part display area 312 may be as shown in the brightness distribution D2, and the brightness of the second part display area 312 may gradually decrease as the distance from the second light source 330 increases.

Corresponding to FIG. 3B, in FIG. 3D, during the second time period, the second light source 330 may send multiple second light beams LB2 to the light guiding plate 350. The light guiding plate 350 may transmit second light beams LB2 to the second part display area 312 of the display panel 310, thereby lighting up the second part display area 312.

The above-mentioned first time period and second time period may be generated periodically alternately, and the screen display operation of the display device 300 may be maintained continuously.

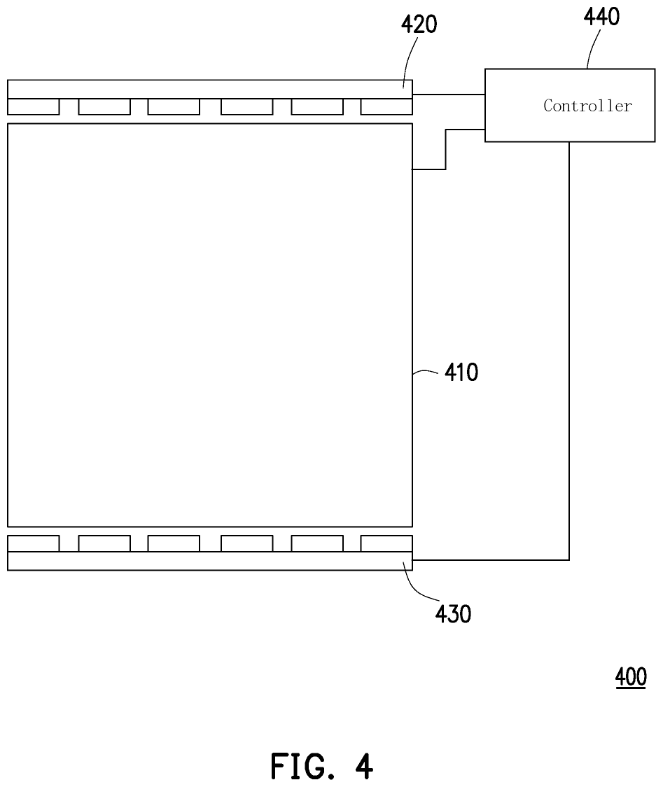

Referring to FIG. 4, FIG. 4 is a schematic view of a display device according to another embodiment of the disclosure. The display device 400 includes a display panel 410, a first light source 420, a second light source 430, and a controller 440. The first light source 420 and the second light source 430 are disposed respectively adjacent to two opposite sides of display panel 410. The controller 440 may be coupled to the display panel 410, the first light source 420, and the second light source 430 for controlling the signal scanning operation of the display panel 410 and the light up operation of the first light source 420 and the second light source 430.

The display device 400 of the embodiment may be disposed in a virtual image display system and configured to display a virtual image, so as to achieve a virtual reality, augmented reality, or mixed reality image display effect.

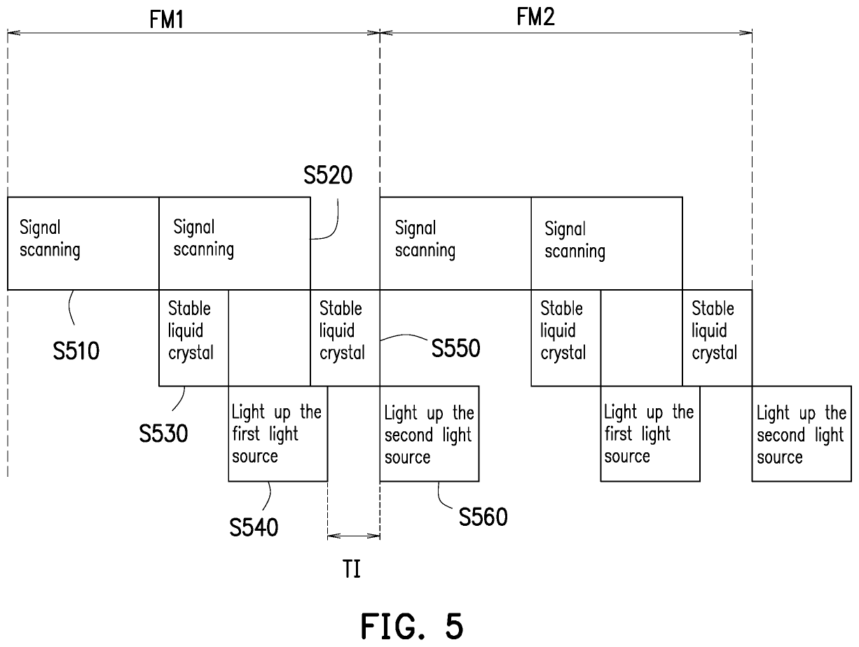

Referring to FIG. 4 and FIG. 5 at the same time, FIG. 5 is a flowchart of a display device according to an embodiment of the disclosure. In FIG. 5, in step S510, during the first frame period, the controller 440 may execute the signal scanning operation of the display data for the first part display area of the display panel 410, thereby executing a data writing operation for the first part display area. Next, in step S520, the controller 440 may execute the signal scanning operation of the display data for the second part display area of the display panel 410, thereby executing a data writing operation for the second part display area.

In addition, step S530 is continues to be completed after S510 ends. In step S530, the pixel (liquid crystal) in the first part display area may be in an inverted state according to the newly written display data. After the end of step S530, all the pixels in the first part display area are in a stable state. After all the pixels in the first part of the display area are in a stable state, the controller 440 may light up the first light source 520 in step S540 and thereby lighting up the first part display area of the display panel 510.

On the other hand, step S520 is continues to be completed after S550 ends. In step S550, the pixel (liquid crystal) in the second part display area may be in an inverted state according to the newly written display data. After the end of step S550, all the pixels in the second part display area are in a stable state. After all the pixels in the second part of the display area are in a stable state, the controller 440 may light up the second light source 530 in step S560 and thereby lighting up the second part display area of the display panel 510.

During the second frame period FM2, the above-mentioned steps may be executed repeatedly to maintain the display operation of the display device 400.

It is worth mentioning that step S560 may be executed during the second frame period FM2, and overlaps with the execution time of the signal scanning operation of the first part display area during the second frame period FM2. In this way, both steps S540 and S560 may be executed after the pixels of the corresponding part of the display area are in a stable state, which may reduce the afterimage phenomenon caused by the unstable pixels and improve the display quality. In this embodiment, steps S540 and S560 do not occur continuously, and steps S540 and S560 may have a non-zero interval time TI.

The controller 440 may be a processor with computing capability. Alternatively, the controller 440 may be a hardware circuit designed through a hardware description language (HDL) or any other digital circuit design method known to those with ordinary knowledge in the art, and implemented through a field programmable logic gate array (FPGA), a complex programmable logic device (CPLD), or an application-specific integrated circuit (ASIC).

In this embodiment, the controller 440 may include a driver for driving and lighting up the first light source 420 and the second light source 430.

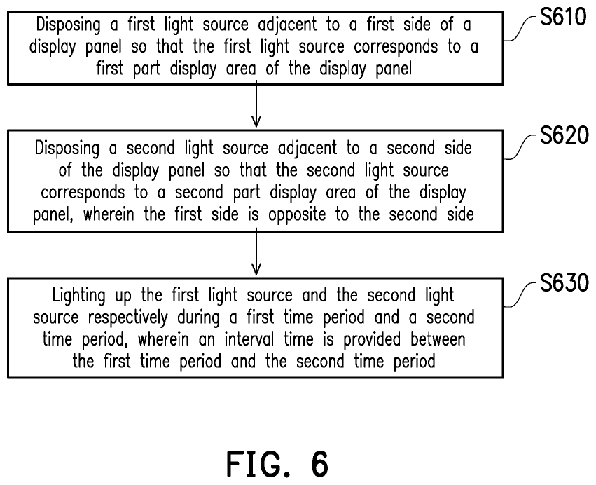

Referring to FIG. 6, FIG. 6 is a flowchart of a control method of a display device according to an embodiment of the disclosure. In step S610, the first light source is disposed adjacent to the first side of the display panel so that the first light source corresponds to the first part display area of the display panel. In addition, in step S620, the second light source is disposed adjacent to the second side of the display panel so that the second light source corresponds to the second part display area of the display panel. In step S630, the first light source and the second light source are lit up respectively during a first time period and a second time period, where an interval time is provided between the first time period and the second time period.

The implementation details of the above steps have been described in detail in the aforementioned embodiments, and will not be repeated here.

To sum up, the display device of the disclosure includes side-mounted light sources disposed on the two opposite sides of the display panel, which are lit up respectively after the corresponding pixels are in a stable state. Thus, the afterimage phenomenon caused by the unstable pixels (liquid crystal inversion) may be reduced and the display quality is improved.

What is claimed is:

1. A display device, comprising:
a display panel;
a first light source, disposed adjacent to a first side of the display panel corresponding to a first part display area of the display panel; and
a second light source, disposed adjacent to a second side of the display panel corresponding to a second part display area of the display panel, wherein the first side is opposite to the second side, wherein the first light source and the second light source are respectively lit up during a first time period and a second time period, and an interval time is provided between the first time period and the second time period.

2. The display device according to claim 1, further comprising:
a light guiding plate, overlapping with the display panel and configured to transmit a plurality of first light beams sent by the first light source to the first part display area and transmit a plurality of second light beams sent by the second light source to the second part display area.

3. The display device according to claim 1, further comprising:
a controller, coupled to the display panel, the first light source, and the second light source,
wherein the controller is configured to:
execute a first data writing operation for the first part display area during a first signal scanning period and light up the first light source during the first time period after a first pixel stable period after the first signal scanning period; and
execute a second data writing operation for the second part display area during a second signal scanning period and light up the second light source during the second time period after a second pixel stable period after the second signal scanning period.

4. The display device according to claim 3, wherein the second signal scanning period overlaps with the first pixel stable period.

5. The display device according to claim 3, wherein a time length of the first signal scanning period and the second signal scanning period is less than one frame period of the display device.

6. The display device according to claim 1, wherein the first part display area and the second part display area partially overlap each other.

7. The display device according to claim 1, wherein the first part display area is adjacent to the first light source and the second part display area is adjacent to the second light source.

8. A control method of a display device, comprising:
disposing a first light source adjacent to a first side of a display panel so that the first light source corresponds to a first part display area of the display panel;
disposing a second light source adjacent to a second side of the display panel so that the second light source corresponds to a second part display area of the display panel, wherein the first side is opposite to the second side; and
lighting up the first light source and the second light source respectively during a first time period and a second time period, wherein an interval time is provided between the first time period and the second time period.

9. The control method according to claim 8, further comprising:
disposing a light guiding plate configured to overlap with the display panel; and
configuring the light guiding plate to transmit a plurality of first light beams sent by the first light source to the first part display area and transmit a plurality of second light beams sent by the second light source to the second part display area.

10. The control method according to claim 8, further comprising:
executing a first data writing operation for the first part display area during a first signal scanning period and lighting up the first light source during the first time period after a first pixel stable period after the first signal scanning period; and
executing a second data writing operation for the second part display area during a second signal scanning period and lighting up the second light source during the second time period after a second pixel stable period after the second signal scanning period.

11. The control method according to claim 10, wherein the second signal scanning period overlaps with the first pixel stable period.

12. The control method according to claim 10, wherein a time length of the first signal scanning period and the second signal scanning period is less than one frame period of the display device.
